(19) United States
(12) Patent Application Publication
(10) Pub. No.: US 2026/0017063 A1
(43) Pub. Date: Jan. 15, 2026

(54) Lean Network Communications Stack with Recovery Protocol for an NVMe Boot Partition

(71) Applicant: Dell Products L.P., Round Rock, TX (US)

(72) Inventors: Vishesh Jain, Raipur (IN); Sarvesh Maurya, Singrauli (IN); Shekar Babu Suryanarayana, Bangalore (IN)

(21) Appl. No.: 18/772,180

(22) Filed: Jul. 14, 2024

(51) Int. Cl. G06F 9/4401

(52) U.S. Cl. CPC G06F 9/4401

(57) ABSTRACT

A firmware management operation. The firmware management operation includes providing an information handling system with a distributed basic input output system (BIOS); retrieving firmware components from a remote network accessible storage location using a lean network communication stack; storing the retrieved firmware components within the distributed BIOS; and, initializing the information handling system using the firmware components retrieved via the lean network communications stack.

### BACKGROUND OF THE INVENTION

### Field of the Invention

The present invention relates to information handling systems. More specifically, embodiments of the invention relate to performing a firmware management operation.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY OF THE INVENTION

In one embodiment the invention relates to a computer-implementable method for performing a firmware management operation, comprising: providing an information handling system with a distributed basic input output system (BIOS); retrieving firmware components from a remote network accessible storage location using a lean network communication stack; storing the retrieved firmware components within the distributed BIOS; and, initializing the information handling system using the firmware components retrieved via the lean network communications stack.

In another embodiment the invention relates to a system comprising: a processor; a data bus coupled to the processor; and a non-transitory, computer-readable storage medium embodying computer program code, the non-transitory, computer-readable storage medium being coupled to the data bus, the computer program code interacting with a plurality of computer operations and comprising instructions executable by the processor and configured for: providing an information handling system with a distributed basic input output system (BIOS); retrieving firmware components from a remote network accessible storage location using a lean network communication stack; storing the retrieved firmware components within the distributed BIOS; and, initializing the information handling system using the firmware components retrieved via the lean network communications stack.

In another embodiment the invention relates to a computer-readable storage medium embodying computer program code, the computer program code comprising computer executable instructions configured for: providing an information handling system with a distributed basic input output system (BIOS); retrieving firmware components from a remote network accessible storage location using a lean network communication stack; storing the retrieved firmware components within the distributed BIOS; and, initializing the information handling system using the firmware components retrieved via the lean network communications stack.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system as implemented in the system and method of the present invention;

FIG. 2 shows a simplified block diagram of multi-processor operating environment;

FIG. 3 shows a simplified block diagram of an architecture-specific distributed firmware management platform;

FIGS. 4a through 4c are a simplified block diagram showing the performance of certain distributed firmware management operations;

FIG. 5 is a simplified block diagram of a failover Common Internet File System (CIFS) Cloud Recovery (CCR) protocol used to recover firmware components from a cloud computing environment (CCE);

FIG. 6 is a simplified block diagram showing the use of a lean network communications stack to securely retrieve firmware components from a CCE;

FIGS. 7a and 7b are simplified block diagrams showing the architecture of a robust network communications stack used to derive the architecture of a lean network communication stack; and

FIGS. 8a and 8b respectively show components associated with a robust network communications stack and a lean network communications stack.

### DETAILED DESCRIPTION

A system, method, and computer-readable medium are disclosed for performing a firmware management operation, described in greater detail herein. Various aspects of the invention reflect an appreciation that it is not uncommon for certain firmware components of a Basic Input/Output System (BIOS) associated with an information handling system (IHS) to be added, deleted, updated, revised, replaced, or restored over time. Likewise, various aspects of the invention reflect an appreciation that such BIOS firmware components are often added, deleted, updated, revised, replaced, or restored to provide security updates, fix known software bugs, improve performance, add new features and functionalities, and so forth.

Various aspects of the invention reflect an appreciation that it is increasingly common for the size of the Basic Input/Output System (BIOS) of an information handling system (IHS) to grow due to the incorporation of advanced features. Accordingly, more and more space may be required within an IHS’s System Peripheral Interface (SPI) memory, which may be limited, or costly to expand, or both. One approach to this issue is to move boot partitions (BPs) for firmware storage from SPI memory to other storage locations that may be faster, yet still persistent, such as Non-Volatile Memory express (NVMe) memory devices.

Likewise, various aspects of the invention reflect an appreciation that migrating BIOS firmware from SPI memory to a boot partition in an NVMe memory device may pose certain challenges. For example, NVMe-based drives are prone to swapping. As a result, when a drive is replaced with a new drive, all previously-installed firmware components are lost, which creates a problem as they may then need to be recovered to perform certain firmware operations.

Various aspects of the invention likewise reflect an appreciation that due to improper power cycles, NVMe-based drives may miss the control execution cycle, resulting in the possibility of data corruption. Accordingly, when an NVMe boot partition is used as an extended firmware store, recovery of any associated corrupted data may be more costly. Furthermore, if the firmware components are not recovered properly, and at the right t time, then a platform boot failure may occur. Likewise, if the platform encounters a NO-Power On Self-Test (POST) issue when NVMe boot partition data is corrupted then there is no way to recover the platform, as all secondary firmware recovery images are stored in the NVMe boot partition.

Likewise, various aspects of the invention reflect an appreciation that no known approach exists for cloud-based, zero touch, automated recovery of firmware data stored in NVMe memory. As a result, service personnel may be required to manually recover boot partition data from a failing NVMe drive, store it to an intermediary device, replace the NVMe drive, and restore the temporarily stored boot partition data to the new NVMe drive. Various aspects of the invention likewise reflect an appreciation that current network-based BIOS firmware recovery approaches generally involve the use of a robust network communications stack to support Wireless Fidelity (WiFi) connectivity and other network communication dependencies. Furthermore, such robust network communication stacks are typically large in size (e.g., greater than two megabytes), which may pose challenges when attempting to store them in SPI memory, where available space may be limited.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, read-only memory (ROM), and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

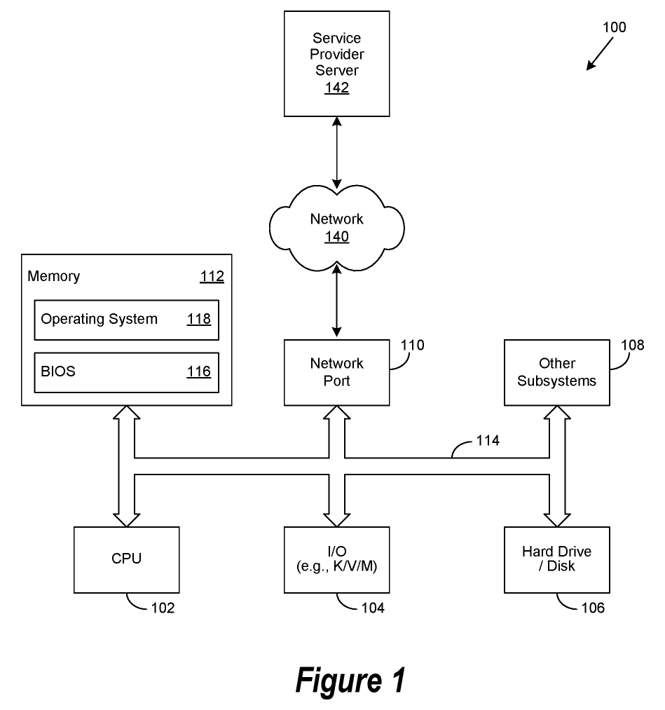

FIG. 1 is a generalized illustration of an information handling system that can be used to implement the system and method of the present invention. In certain embodiments, the information handling system (IHS) 100 may be implemented to include a processor (e.g., central processor unit or “CPU”) 102, various input/output (I/O) devices 104, such as a display, a keyboard, a mouse, a touchpad, or a touchscreen, and associated controllers, a hard drive or disk storage 106, and various other subsystems 108. In various embodiments, the IHS 100 may also be implemented to include a network port 110 operable to connect to a network 140, which in turn may be implemented to provide access to a service provider server 142. In various embodiments, the IHS 100 may likewise be implemented to include system memory 112, which is interconnected to the foregoing via one or more buses 114.

In various embodiments, system memory 112 may be configured to store program code, or data, or both, which in turn may be implemented to be accessible and executable by the CPU 102. In various embodiments, system memory 112 may be implemented using any suitable memory technology. Examples of such memory technology include random access memory (RAM), static RAM (SRAM), dynamic RAM (DRAM), synchronous dynamic RAM (SDRAM), non-volatile RAM (NVRAM), read-only memory (ROM), erasable programmable read-only memory (EPROM), electrically erasable programmable ROM (EEPROM), complementary metal-oxide-semiconductor (CMOS) memory, flash memory, or any other type of computer memory, whether it may be volatile or non-volatile. In various embodiments, system memory 112 may include one or more dual in-line memory modules (DIMMs), each containing one or more RAM modules mounted onto an integrated circuit board.

In various embodiments the system memory 112 may further be implemented to include a Basic Input/Output System (BIOS) 116, or an operating system (OS) 118, or both. Skilled practitioners of the art will be aware that BIOS 116, also known as System BIOS, ROM BIOS, or personal computer (PC) BIOS, is a type of firmware used to provide runtime services for an OS 118 to perform hardware initialization during the booting process of an IHS 100. Those of skill in the art will likewise be aware that firmware is a combination of persistent memory, program code, and data that provides low-level control of an IHS’s 100 hardware. In various embodiments, the BIOS 116 may be implemented to initialize and test certain hardware components of its associated IHS 100 during the booting process (e.g., Power-On Self-Test, or “POST”), followed by loading a boot loader from a particular mass storage device, which in turn may then be used to initialize a kernel.

In various embodiments, such BIOS 116 firmware may be implemented to provide hardware abstraction services to higher-level software such as an OS 118. In various embodiments, BIOS 116 firmware may be implemented in a less complex IHS 100 as an OS 118, performing all control, monitoring, and data manipulation functions. In various embodiments, certain components of a particular IHS 100 may be implemented to have its own firmware, which may store operational variables, data structures, or in general, any sort of information.

In various embodiments, NVRAM may be implemented to store a BIOS 116 associated with the IHS 100. In various embodiments, the NVRAM may also be implemented to hold the initial processor instructions required to bootstrap the IHS 100, store calibration constants, passwords, or setup information, or a combination thereof. In various embodiments, such setup information may be stored as variables in the NVRAM such that the variables are available during system boot from a power-off state. Various embodiments of the invention reflect an appreciation that such variables may need to be modified, revised, updated, restored, or replaced from time to time if they become corrupted. In various embodiments, an NVRAM driver may be implemented to use NVRAM headers to initialize and enable read/write services for updating or restoring such variables. Accordingly, as it relates to various embodiments of the invention, the terms “firmware,” “NVRAM,” or “BIOS” may be used generically and interchangeably.

In various embodiments, the functionality of a BIOS 116 may be implemented according to the Unified Extensible Firmware Interface (UEFI) specification, which describes how an IHS’s 100 firmware interacts with a particular OS 118. Various embodiments of the invention reflect an appreciation that UEFI, as typically implemented, may offer certain features and benefits that are not available from traditional BIOS 116 implementations, such as faster boot times, improved security, support for larger storage devices, and higher definition graphical user interfaces (GUIs). In addition, UEFI stores all data related to the IHS’s 100 initialization and startup within an .efi file, rather than on its associated firmware. In typical implementations, the .efi file may be stored on a special memory partition known as an EFI System Partition (ESP), which also contains the IHS’s 100 bootloader.

In various embodiments, BIOS 116 may be instantiated as a distributed BIOS 116. As used herein, a distributed BIOS 116 broadly refers to a BIOS 116 that includes a plurality of BIOS 116 components, or a plurality of BIOS 116 variables, or a plurality of BIOS 116 storage locations, or a combination thereof. In various embodiments, the distributed BIOS 116 may be implemented to function with any of a plurality of processor environments, described in greater detail herein.

In various embodiments, the IHS 100 may be implemented to perform a firmware management operation. As used herein, a firmware management operation broadly refers to any task, function, operation, procedure, or process performed, directly or indirectly, to store, retrieve, aggregate, disaggregate, add, delete, modify, revise, update, replace, or restore one or more individual BIOS 116 components, described in greater detail herein, or one or more individual BIOS 116 variables, likewise described in greater detail herein, or a combination thereof, in one or more memory 112 locations associated with a particular IHS 100. In various embodiments, the firmware management operation may be implemented to include the performance of a cloud-based firmware recovery (CBFR) operation.

A CBFR operation, as used herein, broadly refers to any function, task, procedure, or process performed, directly or indirectly, within a multi-processor operating environment, or an architecture-specific distributed firmware management platform (ASDFMP), both of which are described in greater detail herein, to automatically locate and retrieve certain Basic Input/Output System (BIOS) firmware components from a remote, network-accessible storage location, likewise described in greater detail herein, and restore them to a particular firmware storage location within the multi-processor operating environment, or the ASDFMP, or a component thereof, for subsequent use by a particular IHS 100. In various embodiments, the CBFR operation may be performed to restore certain BIOS firmware to a boot partition (BP) located within a Non-Volatile Memory express (NVMe) storage device. In certain embodiments, the firmware management operation may be performed during operation of an IHS 100. In various embodiments, performance of the firmware management operation may result in the realization of improved operation of an IHS 100.

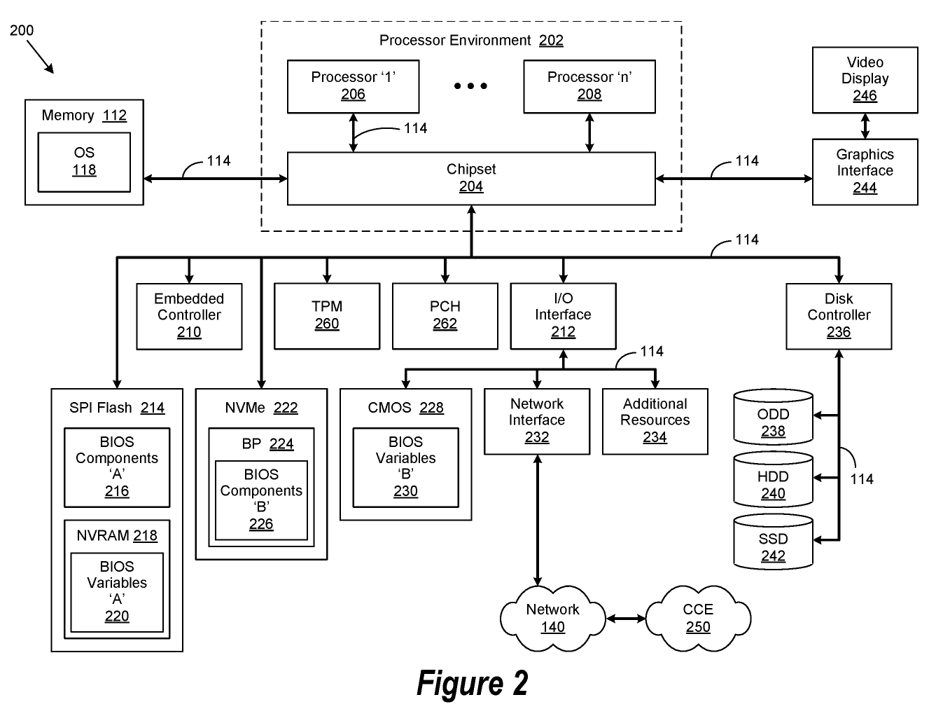

FIG. 2 shows a simplified block diagram of multi-processor operating environment implemented in accordance with an embodiment of the invention. As used herein, a multi-processor operating environment 200, such as that shown in FIG. 2, broadly refers to any instrumentality, or aggregate of instrumentalities, that may be implemented to compute, classify, process, transmit, receive, retrieve, originate, switch, store, display, manifest, detect, record, reproduce, handle, or utilize, or a combination thereof, any form of information, intelligence, or data for business, scientific, control, entertainment, or other purpose, through the use of a particular processor environment (PE) 202. For example, the multi-processor environment 200 may be implemented as a personal computer, a laptop computer, a smart phone, a tablet computer or other consumer electronic device, a network server, a network storage device, or other network communication device, and so forth. In various embodiments, a multi-processor operating environment 200 may be implemented to include processing resources for executing machine-executable code, such as a central processing unit (CPU), a programmable logic array (PLA), an embedded device such as a System-on-a-Chip (SoC), or other control logic hardware.

In various embodiments, the multi-processor operating environment 200 may be implemented to include a PE 202. In various embodiments, the PE 202 may be implemented to include a chipset 204 and one or more processors ‘1’ 206 through ‘n’ 208. In various embodiments, the processors ‘1’ 206 through ‘n’ 208 implemented within a PE 202 may have the same, or different, architectures. In various embodiments, a chipset 204 may be implemented to support one or more architectures corresponding to the processors ‘1’ 206 through ‘n’ 208. In various embodiments, the one or more architectures can include an x86 type processor architecture, an Advanced Reduced Instruction Set Computer (RISC) Machines (ARM) type processor architecture, or a combination thereof. In various embodiments, a processor environment implementing an x86 type processor architecture provides an x86 type processor environment. In various embodiments, a processor environment implementing an ARM type processor architecture provides an ARM type processor environment.

As an example, processors ‘1’ 206 through ‘n’ 208 of a particular PE 202 may be implemented to be the same in a server. In this example, each processor may be assigned to be a resource to one or more virtual machines (VMs). As another example, processor ‘1’ 206 may be implemented as a multi-core processor in a graphics work station, while processor ‘n’ 208 may be implemented a Graphics Processing Unit (GPU), familiar to skilled practitioners of the art.

In various embodiments, each of the processors ‘1’ 206 through ‘n’ 208 of a particular PE 202 may be implemented to run the same OS 118. Likewise, individual processors ‘1’ 206 through ‘n’ 208 of a particular PE 202 may be implemented in various embodiments to run a different same OS 118. For example, processor ‘1’ 206 may be implemented to run Microsoft^{®} Windows^{®}, while processor ‘n’ 208 may be implemented to run a version of Linux^{®}.

In various embodiments, one or more PEs 202 selected from a plurality of PEs 202 may be implemented within the multi-processor operating environment 200. In certain of these embodiments, a particular PE 202 selected from a plurality of PEs 202 may be vendor-specific. In various embodiments, a particular PE 202 selected from a plurality of PEs 202 may be implemented as a System on a Chip (SoC), familiar to those of skill in the art. In various embodiments, the PE 202 may be implemented to include a plurality of vendor-specific SoCs provided by different vendors, or different versions of an SoC provided by the same vendor.

In various embodiments, the multi-processor operating environment 200 may likewise be implemented to include system memory 112. In various embodiments, the system memory 112 may in turn be implemented to include an operating system (OS) 118. In various embodiments, the multi-processor operating environment 200 may be implemented to include an embedded controller (EC) 210, a Trusted Platform Module (TPM) 260, a Platform Controller Hub (PCH) 262, an input/output (I/O) interface 212, a disk controller 236, and a graphics interface 244, or a combination thereof.

In various embodiments, the multi-processor operating environment 200 may likewise be implemented to include Nonvolatile Random Access Memory (NVRAM) 218, Serial Peripheral Interface (SPI) Flash memory 214, Nonvolatile Memory Express (NVMe) 222 memory, and a complementary metal-oxide-semiconductor (CMOS) 228 chip, or a combination thereof. Skilled practitioners of the art will be familiar with NVRAM 218, which in general usage broadly refers to Random Access Memory (RAM) that retains data if power is lost. In various embodiments, NVRAM 218 may be implemented to hold initial processor instructions used to bootstrap an information handling system (IHS), described in greater detail herein. In various embodiments, NVRAM 218 may be implemented in the form of flash memory, such as SPI Flash 214 memory, Erasable Programmable Read-Only Memory (EPROM), Electrically Erasable Programmable Read-Only Memory (EEPROM), or Ferroelectric RAM (F-RAM), Magnetoresistive RAM (MRAM), Phase-Change RAM (PRAM), or a combination thereof.

Those of skill in the art will likewise be familiar with SPI Flash 214 memory, which is a type of EEPROM memory implemented in accordance with the SPI standard, where the data stored within it is architecturally arranged in blocks. Various embodiments of the invention reflect an appreciation that while data stored within SPI Flash memory 214 is erased at the block level, it may be read or written at the byte level. Likewise, various embodiments of the invention reflect an appreciation that the ability to erase blocks of data within SPI Flash 214 memory may be advantageous in certain embodiments as erase speeds can be improved, and as a result, allow information to be stored more efficiently and compactly.

Likewise, skilled practitioners of the art will be familiar with NVMe, which is an open, logical device interface specification for accessing non-volatile storage media implemented within an IHS. Certain embodiments of the invention reflect an appreciation that NVMe 222 memory is currently available in various form factors, such as solid state drives (SSDs), Peripheral Component Interconnect Express (PCIe) memory cards, and M.2 memory cards. Various embodiments of the invention likewise reflect an appreciation that NVMe, as a logical device interface, is able to support low latency and internal parallelism for solid state storage devices, which can reduce Input/Output (I/O) overhead while providing other known performance improvements.

In various embodiments, the SPI Flash 214 memory may be implemented to receive, store, manage, and provide access to one or more Basic Input/Output System (BIOS) components ‘A’ 216. As used herein, a BIOS component broadly refers to one or more discrete portions of firmware program code that may be used, directly or indirectly, by a BIOS during its operation. In various embodiments, the SPI Flash 214 memory may be implemented to include certain NVRAM 218 memory. In various embodiments, the NVRAM 218 memory may in turn be implemented to receive, store, manage, and provide access to one or more BIOS variables ‘A’ 220, such as configuration settings, for use by the BIOS of an associated IHS.

In various embodiments, the NVMe 222 memory may be implemented to include a boot partition (BP) 224. Those of skill in the art will be familiar with the concept of a BP 224, which in common usage broadly refers to a primary memory partition that contains a boot loader, which is a portion of program code responsible for booting the OS 118 of an associated IHS. In various embodiments, the BP 224 may in turn be implemented to receive, store, manage, and provide access to one or more BIOS components ‘B’ 226. In various embodiments, the NVMe 222 memory may be implemented without a BP 224. Nonetheless, the NVMe 222 memory may be implemented in certain of these embodiments to still receive, store, manage, and provide access to one or more BIOS components ‘B’ 226.

In various embodiments, the I/O interface 212 may be implemented to interact with a complementary metal-oxide semiconductor (CMOS) 228 chip. In various embodiments, the CMOS 228 chip may be implemented to include a real-time clock and RAM memory that is backed-up by a battery. In various embodiments, the memory in the CMOS 228 chip may be implemented to receive, store, manage, and provide access to one or more BIOS variables ‘B’ 230.

In various embodiments, the I/O interface 212 may likewise be implemented to interact with a network interface 232, or additional resources 234. or both. In various embodiments, the network interface 232 may be implemented to provide access and connectivity to a network 140. In turn, the network 140 may be implemented in various embodiments to provide access and connectivity to a cloud computing environment (CCE) 250. Skilled practitioners of the art will be familiar with cloud computing, which is defined by the National Institute of Standards and Technology (NIST) as a model for enabling ubiquitous, convenient, on-demand network access to a shared pool of configurable computing resources (e.g., networks, servers, storage, applications, portions of program code, firmware components, data, services, and so forth) that can be rapidly provisioned and released with minimal management effort or service provider interaction.

In various embodiments, additional resources 234 may include a data storage system, additional graphics interfaces, a network interface card (NIC), a sound or video processing card, and so forth. In various embodiments, additional resources 234 may be implemented on a main circuit board of an IHS, or a separate circuit board or add-in card thereof, or a device that is external to the IHS, or a combination thereof. In various embodiments, the disk controller 236 may be implemented to interact with, and manage access to and from, an optical disk drive (ODD) 238, a hard disk drive (HDD) 240, or a solid state drive (SSD) 242, or a combination thereof.

In various embodiments, the graphics interface 242 may be implemented to present visual content on an associated video display. In certain of these embodiments, the graphics interface 242 may likewise be implemented to receive user gesture input from the video display 244, such as through the use of a touch-sensitive screen. In various embodiments, the system memory 112, the chipset 204, one or more processors ‘1’ 206 through ‘n’ 208, the EC 210, the TPM 260, the PCH 262, the SPI Flash 214 memory, the NVMe 222 memory, the I/O interface 212, the CMOS 228 chip, the network interface 232, the additional resources 234, the disk controller 236, the ODD 238, the HDD 240, the SSD 242, the graphics interface 244, and the video display 246 may be implemented to provide and receive data to and from one another via one or more buses 114.

In various embodiments, a firmware management operation may be implemented to include a distributed firmware management operation. As used herein, a distributed firmware management operation broadly refers to a firmware management operation, described in greater detail herein, performed directly, or indirectly, within a multi-processor operating environment 200 to store, retrieve, aggregate, disaggregate, add, delete, modify, revise, update, replace, or restore one or more BIOS components ‘A’ 216 or ‘B’ 226, or one or more BIOS variables ‘A’ 220 or ‘B’ 230, or a combination thereof. In various embodiments, one or more BIOS components ‘A’ 216 or ‘B’ 226, or one or more BIOS variables ‘A’ 220 or ‘B’ 230, or a combination thereof, may be used, individually or in combination with one another, in the performance of a distributed firmware management operation. In various embodiments, performance of the distributed firmware management operation effectively decouples (i.e., minimizes the interrelationship between) one or more BIOS components ‘A’ 216 or ‘B’ 226, or one or more BIOS variables ‘A’ 220 or ‘B’ 230, or a combination thereof, from each other. In various embodiments, the performance of the distributed firmware management operation effectively decouples PE BIOS components from other platform BIOS components, as described herein.

In various embodiments, individual BIOS components ‘A’ 216 or ‘B’ 226 used in the performance of one or more distributed firmware management operations may be located within, or outside of, the multi-processor operating environment 200. As an example, a particular BIOS component ‘A’ 216 or ‘B’ 226 may initially be stored within a cloud computing environment (CCE) 250, described in greater detail herein. In this example, the firmware component may be retrieved from the CCE 250 by the multi-processor operating environment 200 and then respectively stored as firmware components ‘A’ 216 in NVRAM 218, or ‘B’ 226 in NVMe 222 memory, or a combination of the two.

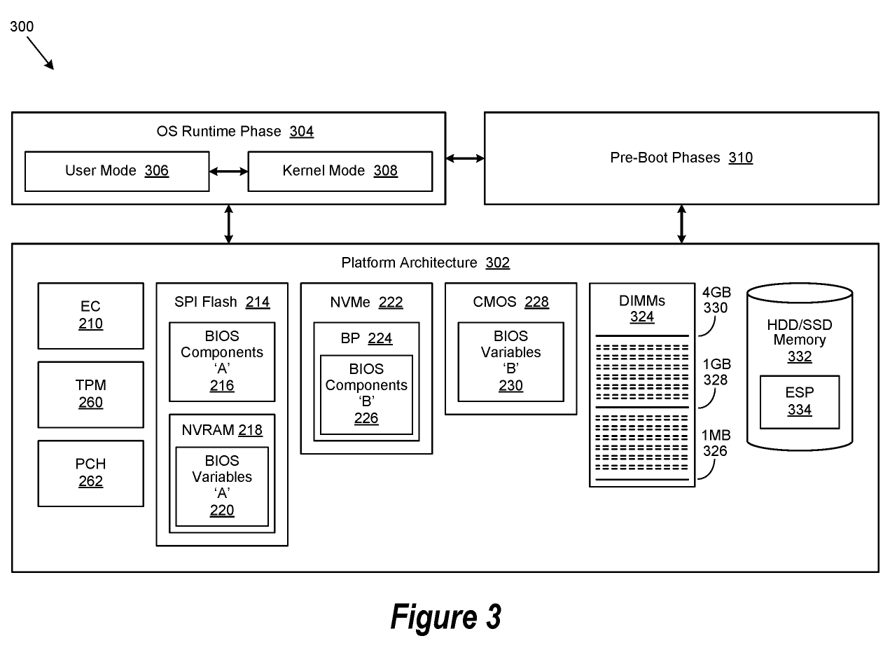

FIG. 3 shows a simplified block diagram of an architecture-specific distributed firmware management platform implemented in accordance with an embodiment of the invention. In various embodiments, the architecture-specific distributed firmware management platform (ASDFMP) 300, and its associated operation, may be implemented to accommodate architecture-specific aspects of a particular information handling system (IHS), described in greater detail herein. As an example, various IHS’s may utilize different processors (e.g., Intel^{®}, AMD^{®}, Qualcom^{®}, Broadcom^{®}, NVidia^{®}, and so forth), and as a result, may require the use of a Basic Input/Output System (BIOS) specific to their respective architecture, or associated operating system (OS), or both, at boot time. In various embodiments, the ASDFMP 300 may be implemented to perform one or more firmware management operations, described in greater detail herein.

In various embodiments, the ASDFMP 300 may be implemented to include a platform architecture 302. In certain of these embodiments, the platform architecture 302 may be implemented to include an embedded controller (EC) 210, a Trusted Platform Module (TPM) 260, a Platform Controller Hub (PCH) 262, Serial Peripheral Interface (SPI) Flash 214 memory, Nonvolatile Memory Express (NVMe) 222 memory, and a complementary metal-oxide-semiconductor (CMOS) 228 chip, or a combination thereof, as described in greater detail herein. In various embodiments, the platform architecture 302 may likewise be implemented to include one or more dual in-line memory modules (DIMMs) 324, and certain hard disk drive (HDD) memory, or solid state drive (SSD) memory, or a combination of the two 332.

In various embodiments, the EC 210 may be implemented, directly or indirectly, within the ASDFMP 300 to provide a root of trust function. As used herein, a root of trust broadly refers to a highly reliable component, such as an EC 210, that performs specific, important security functions. In various embodiments, a root of trust component may be implemented as a building block upon which other components of the ASDFMP 300 can derive security functions.

In various embodiments, the EC 210 may be implemented to perform a root of trust operation. As used herein, a root of trust operation broadly refers to a distributed firmware management operation, described in greater detail herein, performed directly, or indirectly, within an ASFDMP 300 to provide a root of trust by leveraging a secure interface to ensure integrity and security of communication between certain components of the ASDFMP 300. In various embodiments, one or more root of trust operations may be performed to enhance the security and trustworthiness of the ASDFMP 300.

Skilled practitioners of the art will be familiar with a TPM 260, which is an international standard for a secure crypto processor, typically implemented as a dedicated microcontroller designed to secure various hardware components of an ASDFMP 300 through the use of integrated cryptographic keys. In various embodiments, a TPM 260 may be implemented to increase the security of an ASDFMP 300 and to protect it against certain firmware attacks. In various embodiments, a TPM 260 may be implemented in combination with an EC 210 to perform a root of trust operation.

Those of skill in the art will likewise be familiar with a PCH 262, which broadly refers to a family of chipsets manufactured by Intel^{®} to control certain data paths and support functions used in conjunction with Intel^{®} processors. However, as used herein, a PCH 262 may broadly refer to one or more processor-agnostic functionalities of an ASDFMP 300 that may be used, directly or indirectly within it, to control various data paths and support functions associated with a particular processor. Examples of such processors include those manufactured by Intel^{®}, AMD^{®}, Qualcomm^{®}, Broadcom^{®}, NVidia^{®}, and so forth. Accordingly, various embodiments of the invention reflect an appreciation that provision of such PCH 262 functionalities may require a different implementation for each processor architecture.

In various embodiments, the SPI Flash 214 memory may be implemented to receive, store, manage, and provide access to one or more BIOS components ‘A’ 216, as described in greater detail herein. In various embodiments, the SPI Flash 214 memory may likewise be implemented to include certain NVRAM 218 memory. In various embodiments, the NVRAM 218 memory may in turn be implemented to receive, store, manage, and provide access to one or more BIOS variables ‘A’ 220, as described in greater detail herein.

In various embodiments, the NVMe 222 memory may be implemented to include a boot partition (BP) 224, described in greater detail herein. In various embodiments, the BP 224 may in turn be implemented to receive, store, and provide access to, one or more BIOS components ‘B’ 226. In various embodiments, the NVMe 222 memory may be implemented without a BP 224. Nonetheless, the NVMe 222 memory may be implemented in certain of these embodiments to still receive, store, manage, and provide access to one or more BIOS components ‘B’ 226. In various embodiments, as likewise described in greater detail herein, the CMOS 228 chip may be implemented to receive, store, and provide access to, one or more BIOS variables ‘B’ 230.

In various embodiments, the one or more DIMMs 324 may be implemented to include one or more RAM modules mounted onto an integrated circuit board. In various embodiments, the one or more DIMMs 324 may be partitioned into a low region of memory, such as from 1 megabyte (MB) 326 to 1 gigabyte (GB) 328, and a high region of memory, such as from 1GB 328 to 4GB 330. In these embodiments, the amount of memory allocated to the low and high memory regions, the memory addresses within the one or more DIMMs 324 where such allocation may occur, and how such allocation may be performed, is a matter of design choice.

In various embodiments, the HDD/SDD memory 332 may be implemented to include an extensible firmware interface (EFI) system partition (ESP) 334. Skilled practitioners of the art will be familiar with an ESP 334, which is usually implemented as a partition on a mass storage device, such as HDD/SSD memory 332, which in turn is used by an associated IHS implemented with a Unified Extensible Firmware Interface (UEFI), described in greater detail herein. In such implementations, the UEFI loads files stored within the ESP 334 to begin installing Operating System (OS) and associated utility files. In various embodiments, the ESP 334 may be implemented to contain the boot loaders, or kernel images, for all installed OS’s that may be contained in other memory partitions, device driver files for hardware devices present in its associated IHS and used by the firmware at boot time, system utility programs that are intended to be run before a particular OS is booted, and data files such as error logs.

In various embodiments, the ASDFMP 300 may be implemented to include an OS runtime phase 304, and various pre-boot phases 310, all of which are described in greater detail herein. In various embodiments, the OS runtime phase 304 may be implemented to include a user mode 306 and a kernel mode 308, both of which are likewise described in greater detail herein. In various embodiments, certain components, processes, or operations, or a combination thereof, respectively associated with the OS runtime phase 304 and the pre-boot phases 310, may be implemented to interact with various components of the platform architecture 302, as likewise described in greater detail herein.

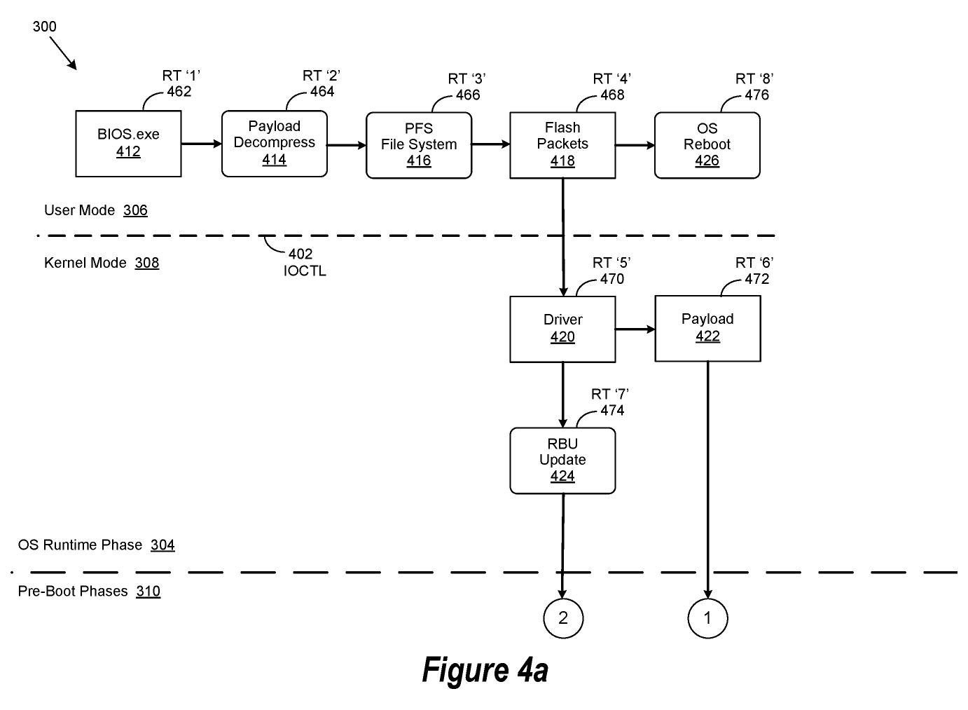

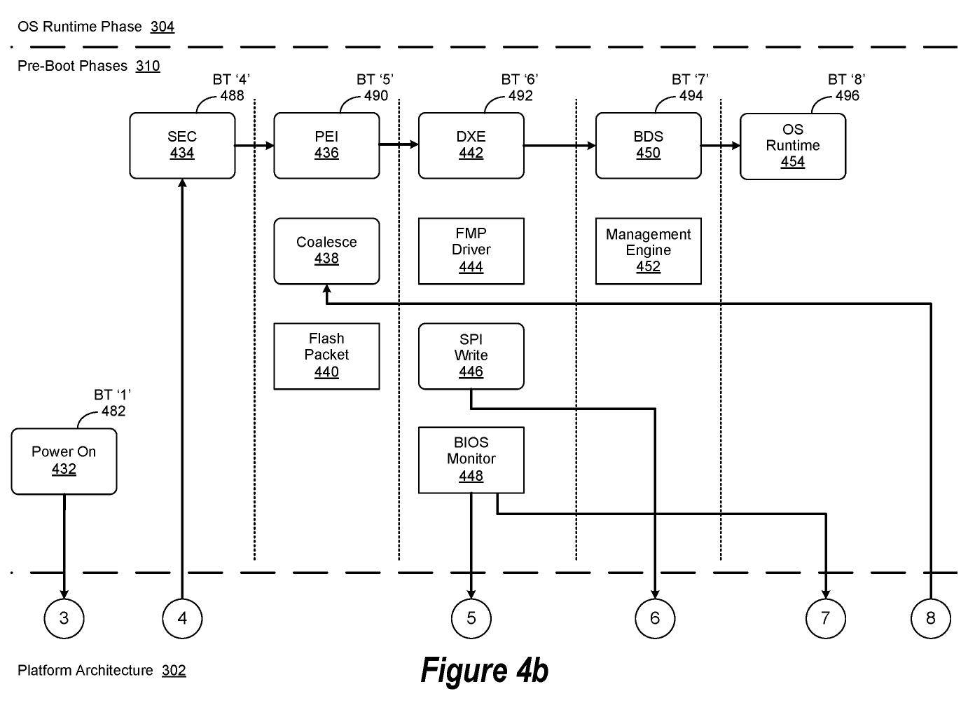

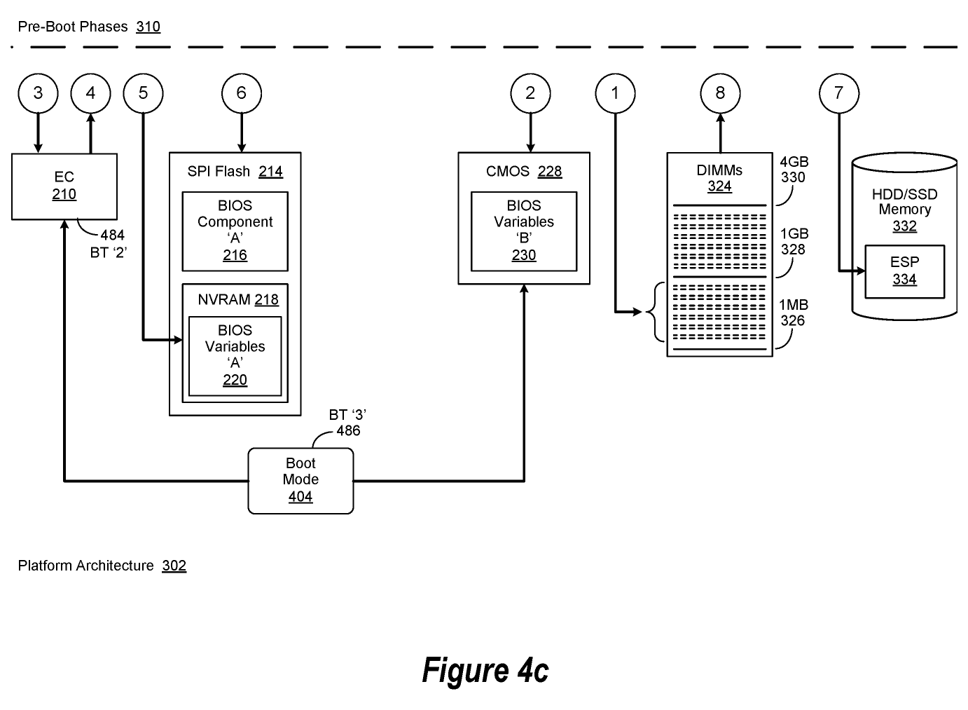

FIGS. 4a through 4c are a simplified block diagram showing an architecture-specific distributed firmware management platform (ASDFMP) implemented in accordance with an embodiment of the invention to perform certain distributed firmware management operations. In certain embodiments, the ASDFMP 300 may be implemented to include an Operating System (OS) runtime phase 304, various pre-boot phases 310, and a platform architecture 302. In various embodiments, as described in greater detail herein, the platform architecture 302 may be implemented to include an embedded controller (EC) 210, Serial Peripheral Interface (SPI) Flash 214 memory, and a complementary metal-oxide-semiconductor (CMOS) 228 chip, or a combination thereof. In various embodiments, the platform architecture 302 may likewise be implemented to include one or more dual in-line memory modules (DIMMs) 324, and certain hard disk drive (HDD) memory, or solid state drive (SSD) memory, or a combination of the two 332.

In various embodiments, the SPI Flash 214 memory may be implemented to receive, store, manage, and provide access to one or more Basic Input/Output System (BIOS) components ‘A’ 216, described in greater detail herein. In various embodiments, the SPI Flash 214 memory may likewise be implemented to include certain NVRAM 218 memory, likewise described in greater detail herein. In various embodiments, the NVRAM 218 memory may in turn be implemented to receive, store, manage, and provide access to one or more BIOS variables ‘A’ 220, as described in greater detail herein.

In various embodiments, the OS runtime phase 304 may be implemented to include a user mode 306 and a kernel mode 308. Skilled practitioners of the art will be aware that user mode 306 generally refers to a restricted mode that limits software access to system resources, while kernel mode 308 generally refers to a privileged mode that allows software to access system resources and perform privileged operations. In various embodiments, an Input/Output Control (IOCTL) 402 operation, familiar to those of skill in the art, may be performed to switch between user mode 306 and kernel mode 308. Those of skill in the art will likewise be aware that such mode switching generally involves saving the current context of an associated information handling system’s (IHS’s) processor in memory, switching to the new mode, and loading the new context into the processor.

Referring now to FIG. 4a, a distributed firmware management operation may be initiated by the ASDFMP 300 receiving a BIOS.exe 412 file in runtime (RT) step ‘1’ 462. In various embodiments, the BIOS.exe 412 file may be implemented as the combination of a flash memory utility and a payload of firmware components, described in greater detail herein. Then, in RT step ‘2’ 464 the BIOS.exe 412 is executed to decompress 414 its payload, which is then converted in RT step ‘3’ 466 into a payload file system (PFS) 416.

Flash memory packets 418 are then extracted from the PFS 416 if RT step ‘4’ 468 and provided to a memory driver 420 in RT step ‘5’ 470 to create a memory payload 422. The resulting memory payload 422 is then loaded into a lower memory region of one or more DIMMs 324, such as between 1 megabyte (MB) 326 and 1 gigabyte (GB) 328. Thereafter, a Remote BIOS Update (RBU) 424 operation may be performed in RT step ‘7’ to update certain BIOS variables ‘B’ 230 stored in the CMOS 328 chip. An OS reboot 426 operation is then performed in RT step ‘8’ 476.

Once the OS reboot 426 operation has been performed in RT step ‘8’ 476, power is applied 432 to the ASDFMP 300 in pre-boot time (BT) step ‘1’ 432. An embedded controller (EC) 210 is then invoked in BT step ‘2’ 464 which results in the activation of a boot mode 404 in BT step ‘3’ 486. In various embodiments, the boot mode 404 may be activated in BT step ‘3’ 486 by retrieving, and using, certain BIOS variables ‘B’ stored in the CMOS 228 chip.

One or more security (SEC) 434 phase operations may then be performed in BT step ‘4’ 488, followed by the performance of one or more Pre Extensible Firmware Interface (EFI) Initialization (PEI) 436 phase operations in BT step ‘5’ 490. In various embodiments, the one or more SEC 434 phase operations may be implemented to secure the boot process by preventing the loading of Unified Extensible Firmware Interface (UEFI) drivers, or boot loaders, that are not signed with an acceptable digital signature. In various embodiments, a trusted platform module (TPM), familiar to skilled practitioners of the art, may be used in the performance of one or more SEC 434 phase operations.

Those of skill in the art will likewise be aware that PEI 436 phase operations are generally performed to initialize permanent memory within a particular IHS to load and invoke initial configuration routines specific to its associated processor environment (PE), described in greater detail herein. In various embodiments, performance of the PEI 436 phase operation in BT step ‘5’ 490 may include one of more packet coalescing 438 operations being performed to coalesce individual flash memory packets previously stored in a low memory region of one or more DIMMs in RT step ‘6’ 472. In various embodiments, the individual flash memory packets may then be stored as one or more coalesced flash memory packets 440.

In various embodiments, a firmware management protocol (FMP) may be used in the performance of a Driver eXecution Environment (DXE) 442 phase operation in BT step 6’ 492 to perform an SPI write 446 operation to write the coalesced flash memory packets 440 to SPI Flash 214 memory. Skilled practitioners of the art will be familiar with a DXE 442, which as typically implemented includes a DXE Core, a DXE Dispatcher, and one or more Firmware Management Protocol (FMP) drivers 444. In general, the DXE Core component is responsible for producing a set of boot services, DXE services, and RT Services. Likewise, the DXE Dispatcher component is responsible for discovering and executing FMP drivers 444 in the correct order. In turn, the FMP drivers 444 are responsible for initializing the IHS’s processor environment (PE), described in greater detail herein. In various embodiments, the SPI write 446 operation may be performed to write certain flash memory packets associated with certain BIOS components ‘A’ 216, or certain BIOS variables ‘A’ 220, or a combination of the two. In various embodiments, the flash memory packets may contain new, updated, modified, revised, or replacement BIOS components ‘A’ 216, or BIOS variables ‘A’ 220, or a combination of the two.

In various embodiments, a BIOS monitor 448, such as BIOS IQ, produced by Dell^{®} Incorporated, of Round Rock, Texas, may be implemented within the DXE 442 phase to monitor the current values of certain BIOS variables ‘A’ 220 stored in NVRAM 218, which in certain embodiments, may be implemented within SPI Flash 214 memory. In various embodiments, the BIOS monitor 448 may likewise be implemented to monitor the status of certain data stored in the ESP 334, described in greater detail herein. Once DXE 442 phase operations are completed in BT step ‘6’ 494, the OS is then booted. In various embodiments, a boot device selection (BDS) 450 phase operation is then performed in BT step ‘7’ 494 to select a boot device. In various embodiments, a management engine (ME) 452, such as the ME 452 produced by Intel^{®} Corporation of Santa Clara, California, may be implemented to use the selected boot device in BT step ‘8’ 496 to boot the ASDFMP 300 into an OS runtime 454 state.

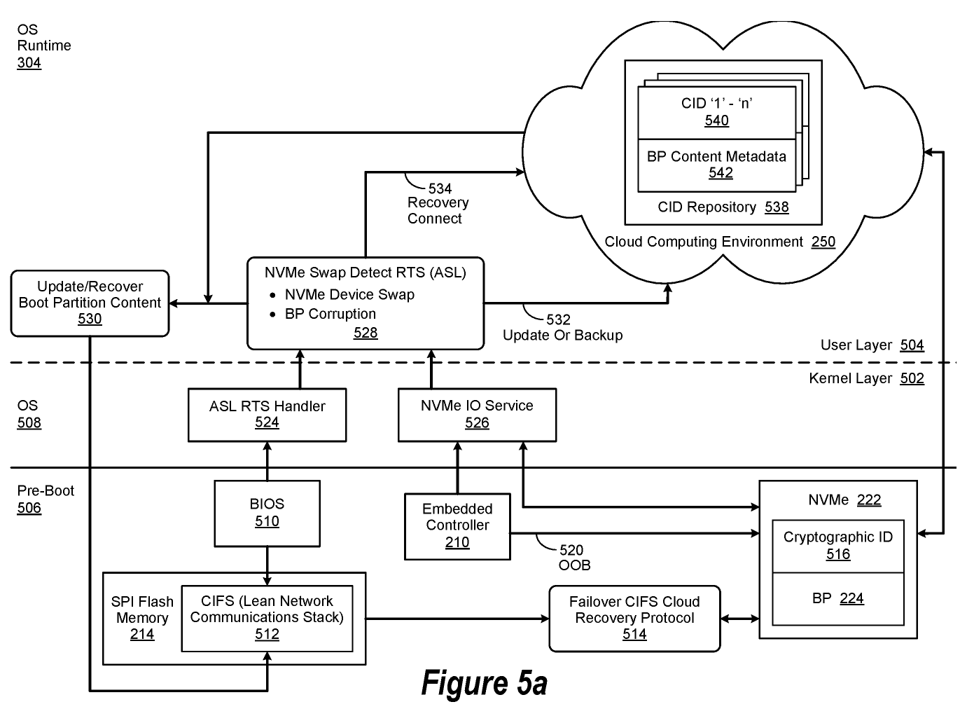

FIG. 5 is a simplified block diagram of a failover Common Internet File System (CIFS) Cloud Recovery (CCR) protocol implemented in accordance with an embodiment of the invention to recover firmware components from a remote, network-accessible storage location. In various embodiments, the failover CCR protocol 514 may be implemented within an architecture-specific distributed firmware management platform (ASDFMP), described in greater detail herein. As described in greater detail herein, the ASDFMP may be implemented in certain embodiments to include an Operating System (OS) runtime phase 304, an OS 508, and a pre-boot phase 506. In various embodiments, a user layer 504, familiar to skilled practitioners of the art, may be implemented to include the OS runtime phase 304. In various embodiments, a kernel layer 502, likewise familiar to those of skill in the art, may be implemented to include the OS 508 and the pre-boot phase 508.

In various embodiments, a firmware recovery operation, described in greater detail herein, may be performed to securely locate, retrieve, and restore certain firmware components stored in a remote, network-accessible storage location to a boot partition (BP) 224 located in an associated Non-Volatile Memory express (NVMe) 222 storage device. In various embodiments, the firmware recover operation includes a cloud-based firmware recovery (CBFR) operation. In various embodiments, a cloud-based firmware recovery operation, described in greater detail herein, may be performed to securely locate, retrieve, and restore certain firmware components stored in a cloud-based remote, network-accessible storage location to a boot partition (BP) 224 located in an associated Non-Volatile Memory express (NVMe) 222 storage device. In certain of these embodiments, an NVMe swap detect service 528 may be implemented to perform one or more integrity check operations on the NVMe 222 storage device’s BP 224 during pre-boot 506 operations. In various embodiments, an embedded controller (EC) 210, described in greater detail herein, may be used in the performance of one or more CBFR operations, likewise described in greater detail herein.

In various embodiments, the EC 210 may be implemented to perform one or more CBFR operations by interacting with a Non-Volatile Memory Express (NVMe) Input/Out (IO) service 526. In various embodiments, the NVMe IO service 526 may be implemented to perform one or more CBFR operations by interacting with a particular NVMe 222 storage device. In various embodiments, the EC 210 may be implemented to perform certain out-of-band (OOB) communication operations when interacting with a particular NVMe 222 storage device. In various embodiments, the NVMe IO service 528 may be implemented in the performance of one or more CBFR operations by providing one or more IO services to allow an NVMe swap detect module 528 to communicate with a particular NVMe 222 storage device.

In various embodiments, a cryptographic ID (CID) 516 may be implemented to uniquely identify a particular NVMe 222 storage device. In various embodiments, a data center asset key, certain service tag information, certain firmware globally unique identifier (GUID) information, or a BP 224 ID, or a combination thereof, may be used to generate such a CID 516. In various embodiments, a CID 516 may be generated in a factory environment and may be backed-up in a CID repository 538 implemented within a remote, network-accessible storage location. In various embodiments, the remote, network-accessible storage location may be implemented in a cloud computing environment (CCE) 250, described in greater detail herein. In various embodiments, the CID repository 538 may be implemented to respectively store individual CID’s ‘1’ through ‘n’ 540 and their associated BP content metadata 542.

In various embodiments, an NVME 222 storage device’s BP content metadata 542 may be updated and synced within the CID repository 538 after every successful firmware component update or restoration. In various embodiments a CID 516 associated with a particular NVMe 222 storage device may be used to retrieve its associated BP 224 content from the CID repository 528. In various embodiments, a CIFS lean network communications stack 512, described in greater detail herein, may be implemented within Serial Peripheral Interface (SPI) 214 flash memory. In various embodiments, the CIFS lean network communications stack 512 may be implemented to support CCR protocol 514 requests for the BP 224 content payload for a particular NVMe 222 storage device from the CID repository 538 if an NVMe 222 drive swap, or if BP 224 data corruption, is detected during pre-boot 506 operations.

In various embodiments, a Basic Input/Output System (BIOS) 510 module may be implemented during the performance of one or more CBFR operations to interact with the CIFS lean network communications stack 512 during the pre-boot phase. In various embodiments, the BIOS 510 module may likewise be implemented during the performance of one or more CBFR to interact with an Array Support Library (ASL) runtime service (RTS) handler 524 module and the OS 506. In various embodiments, the NVMe swap detect module 528 may be implemented during the performance of one or more CBFR operations to interact with the ASL RTS handler 524 module, which in certain embodiments may be implemented to monitor for any NVMe 222 storage device swaps, or BP 224 content corruption, at OS runtime 304, and if detected, trigger an event to update the BP 224 content of its associated NVMe 222 storage device. In various embodiments, the failover CRR protocol 514 may be used during OS runtime 304 to synchronize BP 224 content provided by a particular CID repository 538. In various embodiments, an NVMe Input/Output (IO) service 526 may be used to update the content stored in the BP 224 of the NVMe 222 storage device after it is synchronized.

In various embodiments, the NVMe swap detect 528 module may be implemented during the performance of one of more CBFR operations to update, or backup 532, certain BP 224 content stored in the CID repository 536. In various embodiments, the NVMe swap detect 528 module may be implemented during the performance of one or more CBFR operations to connect 534 to a remote, network-accessible storage location, described in greater detail herein, to update or recover 530 certain BP 224 content. In certain of these embodiments, the CIFS lean network communications stack 512 may be used by the NVMe swap detect 528 module in the performance of one or more CBFR operations to update or recover 530 certain BP 224 content.

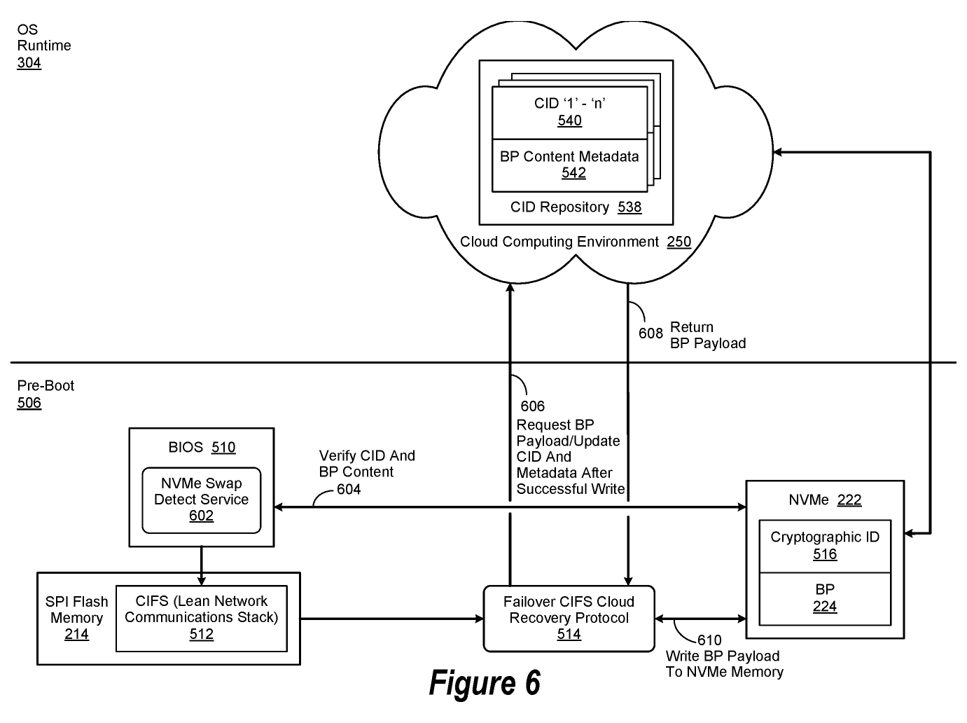

FIG. 6 is a simplified block diagram showing the use of a lean network communications stack implemented in accordance with an embodiment of the invention to securely retrieve firmware components from a remote, network-accessible storage location. In various embodiments, a lean network communications stack 512, described in greater detail herein, may be based upon the Common Internet File System (CIFS) protocol. In certain of these embodiments, the CIFS lean network communications stack 512 may be used for secure location, retrieval, and recovery of certain Basic Input/Output System (BIOS) 510 firmware components, as likewise described in greater detail herein. Various embodiments of the invention reflect an appreciation that such a lean network communications stack 512 will generally be smaller in size compared to a typical robust network communication stack used to enable the Secure Hypertext Transport Protocol (HTTPs). Accordingly, various embodiments of the invention reflect an appreciation that the use of such a CIFS lean network communications stack 512 may save limited storage space typically available in Serial Peripheral Interface (SPI) flash memory 214, as well as reducing the need for maintaining multiple services and security certificates.

In various embodiments, a cryptographic ID (CID) repository 538 may be implemented in a remote, network-accessible storage location to store certain boot partition metadata 542 associated with each unique cryptographic identifier (CID) 516 corresponding to an associated Non-Volatile Memory express (NVMe) 222 storage device. In various embodiments, the remote, network-accessible storage location may be implanted within a cloud computing environment (CCE) 250, described in greater detail herein.

In various embodiments, such boot partition (BP) metadata 542 may be automatically retrieved from the CID repository 538, described in greater detail herein, and used to securely locate, retrieve, and recover associated BP 224 firmware components. In various embodiments, a CIFS Cloud Recovery (CCR) protocol 514, likewise described in greater detail herein, may be implemented to locate, retrieve, and recover such associated BP 224 firmware components if they are corrupted or if a particular NVMe 222 storage device is swapped or replaced.

In various embodiments, network-based location, retrieval and recovery of certain firmware components may be automatically initiated at operating system (OS) runtime 304, without need of any additional resources, as the lean network communications stack 512 described in greater detail herein may be based upon the CIFS protocol, which is typically available within an OS. In various embodiments, the lean network communication stack 512 may be implemented to be self-contained, and as such, may likewise be implemented to operate independently of wireless communication protocols, such as Bluetooth^{®}, and other network communication drivers. In various embodiments, the lean network communication stack 512 may be implemented to be lightweight by optimizing how the stack is initiated by Universal Network Driver Interface (UNDI) and optimized thin Secure Network Protocol (SNP) drivers, as described in greater detail herein.

In various embodiments, as shown in FIG. 6, a Basic Input/Output System (BIOS) module may be implemented to include an NVMe swap detect service 602. In various embodiments, the NVME swap detect service 602 may be implemented during the performance of one or more cloud-based firmware recovery (CBFR) operations, described in greater detail herein, to verify 604 the cryptographic identifier (CID) 516 of a particular NVMe 222 storage device and certain associated Boot Partition (BP) 224 content stored therein.

In various embodiments, a failover CIFS cloud recover protocol 514, likewise described in greater detail herein, may be implemented during the performance of one or more CBFT operations to request 606 a particular BP payload from an associated CID repository 538, described in greater detail herein, and afterwards update a corresponding CID ‘1’ – ‘n’ 540 and BP content metadata 542 upon a successful write operation. In various embodiments, the failover CIFS cloud recover protocol 514 may be implemented during the performance of one or more CBFR operations to retrieve the requested BP payload and write 610 it to a particular NVMe 222 storage device.

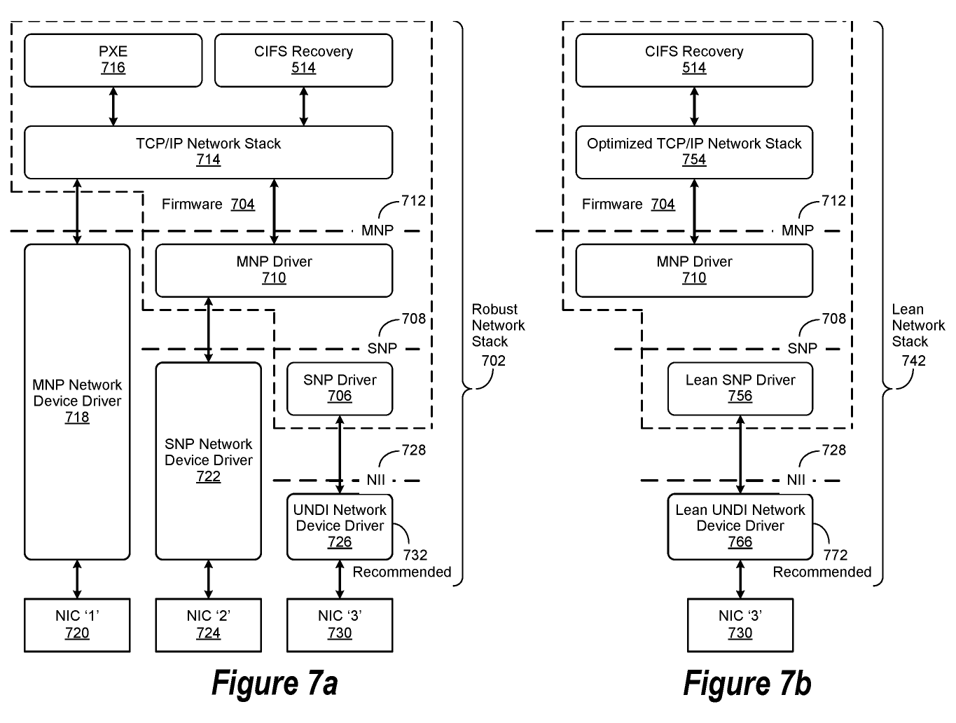

FIGS. 7a and 7b are simplified block diagrams showing the architecture of a complex network communications stack used to derive the architecture of a lean network communication stack implemented in accordance with an embodiment of the invention. As used herein, a robust network communications stack 702, often referred to as a full network communication stack, broadly refers to a set of network components, such as communication protocols and drivers, implemented to support a variety of network communication approaches. Various embodiments of the invention reflect an appreciation that a particular robust network communications stack 702, such as that shown in FIG. 7a, may include certain network components that may, or may not, be used in the performance of a cloud-based firmware recovery (CBFR) operation, described in greater detail herein. Various embodiments of the invention further reflect an appreciation that such a robust network communications stack is often implemented in Serial Peripheral Interface (SPI) memory, and when it is, may consume limited storage space therein. Furthermore, various embodiments of the invention reflect and appreciation that certain components of a robust network communications stack 702 may not be needed for certain network communications operations familiar to skilled practitioners of the art, and as such, consume space within SPI memory that might be better used for other purposes.

In various embodiments, certain components of robust a network communication stack 702 may be implemented to support one peripheral, while other components may be implemented to support another. For example, as shown in FIG. 7a, a robust network communication stack 702 may be implemented to include a Universal Network Driver Interface (UNDI) 726 device driver to support the Network Interface Identifier (NII) 728 protocol layer for a particular peripheral, such as network interface card (NIC) ‘3’ 730. To continue the example, the robust network communication stack 702 may likewise be implemented to include a Secure Network Protocol (SNP) driver 706, and an SNP network device driver 722, to support the SNP 706 protocol. In this example, the SNP driver 706 and the SNP network device driver 722 may respectively be implemented to support the SNP 706 protocol for NIC ‘3’ 730 and ‘2’ 724.

To continue the example shown in FIG. 7a, the robust network communication stack 702 may be implemented to include a Managed Network Protocol (MNP) driver 710, and an MNP network device driver 718 to support the MNP 712 protocol. In this example, the MNP driver 710 may be implemented to support the MNP protocol 712 for NICs ‘3’ 730 and ‘2’ 724, while the MNP network device driver 718 may be implemented to support the MNP 712 protocol for Nic ‘1’ 720. To continue the example further, a Telecommunications Control Protocol/Internet Protocol (TCP/IP) 714 network protocol stack may be implemented to interface to both the MNP driver 710 and the MNP network device driver 718. In various embodiments, the TCP/IP 714 network protocol stack may further be implemented to interface to a Pre-boot Execution Environment (PXE) 716, familiar to skilled practitioners of the art, as well as a Common Internet File System (CIFS) recovery 514 module, described in greater detail herein.

In various embodiments, certain components of the robust network communications stack 702 may be recommended 732 to support a particular peripheral, such as NIC ‘3’ 730. For example, as shown in FIG. 7a, the SNP driver 706, the MNP driver 710, the TCP/IP 714 network protocol stack, the PXE 716, and the CIFS recovery 514 module, all of which may be stored in firmware 704, may be recommended 732, in addition to the UNDI network device driver 726, to support NIC ‘3’ 730. In various embodiments, the firmware 704 may be stored in Serial Peripheral Interface (SPI) memory, as described in greater detail herein.

In contrast, as used herein, a lean network communications stack 742, often referred to as a thin network communication stack, broadly refers to a particular set of known network communication components configured to be just sufficient to establishing and maintaining a communication session with a remote, network-accessible storage location to locate and retrieve certain firmware components for restoration to a particular firmware storage location, such as a boot partition (BP) implemented on a Non-Volatile Memory Express (NVMe) storage device, described in greater detail herein. In various embodiments, the lean network communications stack 742 may be implemented to include certain network communication components of a robust network stack 702, such as an MNP driver 710 and a CIFS recovery 514 module. In various embodiments, the lean network communications stack 742 may be implemented to include certain network communication components of a robust network stack 702, such as the optimized TCP/IP 754 network protocol stack, the lean SNP driver 756, and the lean UNDI network device driver 766.

In various embodiments, the optimized TCP/IP 754 network protocol stack is a reconfigured TCP/IP network protocol stack which is configured to reduce the memory footprint of the protocol stack, narrow the functionality of the protocol stack, increase the efficiency of the protocol stack, or a combination thereof. In various embodiments, the lean SNP driver 756 is a reconfigured SNP driver which is configured to reduce the memory footprint of the driver, narrow the functionality of the driver, increase the efficiency of the driver, or a combination thereof. In various embodiments, the lean UNDI network device driver 766 is a reconfigured UNDI network device driver which is configured to reduce the memory footprint of the driver, narrow the functionality of the driver, increase the efficiency of the driver, or a combination thereof. In various embodiments, the reconfiguration of the TCP/IP 750 network protocol stack, the lean SNP driver 756, the lean UNDI network device driver 766, or a combination thereof, is focused on maximizing communication functionality of the components, while removing functionality unrelated to communication. In various embodiments, the use of the lean network communications stack 742 may be recommended 772 for use in the performance of certain CBFR operations as described in greater detail herein.

Various embodiments of the invention reflect an appreciation that network drivers typically used for Local Area Network (LAN)-on-mainboard network devices, or add-in network cards, that are implemented with a Unified Extensible Firmware Interface (UEFI) Hypertext Transfer Protocol (HTTP) network communication stack are typically Universal Serial Bus (USB) or Peripheral Component Interconnect (PCI) drivers, which generally are complex and have certain known dependencies. In various embodiments, a network device driver may be implemented as a UNDI 726 device driver to reduce its complexity and size by reusing certain SNP 706 driver components with basic functionalities that may already be available in system firmware 704. In various embodiments, such implementations may provide the added advantage of being able to dynamically load and unload drivers when, and as, required.

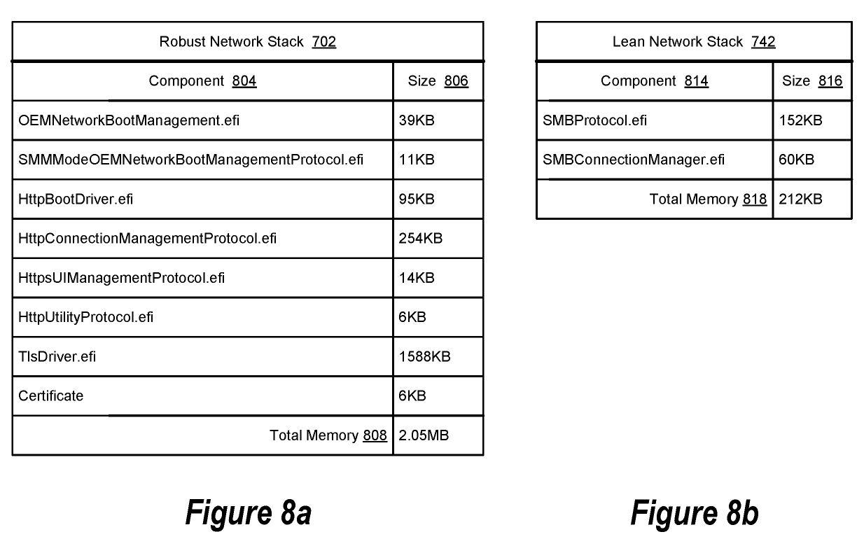

FIGS. 8a and 8b respectively show components associated with a robust network communications stack and a lean network communications stack implemented in accordance with an embodiment of the invention. As shown in FIGS. 8a and 8b, a robust 702 network communications stack may require more than 2MB of Serial Peripheral Interface (SPI) memory 808, while a lean 742 network communications stack may be implemented to need less than 250KB of SPI memory 818. In various embodiments, a robust 702 network communication stack may be implemented to include numerous components 804, each of which may be relatively large in size 806 for their respective functionality. Conversely, a lean 742 network communication stack may be implemented in various embodiments to include a lesser number of components 814, which likewise may be relatively small in size 816 for their relative functionality.

Various embodiments of the invention reflect an appreciation that typical robust 702 network communications stacks may be implemented to rely upon Transport Layer Security (TLS) for security, which generally requires additional maintenance overhead if a new vulnerability is discovered. Likewise, the use of TLS for security typically requires maintaining third party certificates for ensuring secure connections with a cloud computing environment (CCE), described in greater detail herein. Conversely, a lean 742 network communications stack, likewise described in greater detail herein, may be implemented to use certain propriety security approaches to overcome these limitations.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A computer-implementable method for performing a firmware management operation, comprising:
providing an information handling system with a distributed basic input output system (BIOS);
retrieving firmware components from a remote network accessible storage location using a lean network communication stack;
storing the retrieved firmware components within the distributed BIOS; and,
initializing the information handling system using the firmware components retrieved via the lean network communications stack.

2. The method of claim 1, wherein:
the firmware components are retrieved using a common internet file system recovery protocol.

3. The method of claim 1, wherein:
the lean network communications stack comprises a plurality of network communication components, the plurality of network communication components being just sufficient to establish and maintain a communication session with the remote network accessible storage location.

4. The method of claim 3, wherein:
the plurality of network communication components includes an optimized Telecommunications Control Protocol/Internet Protocol (TCP/IP) network protocol stack, a lean secure network protocol (SNP) driver and a lean universal network driver interface (UNDI) network device driver.

5. The method of claim 3, wherein:
the plurality of network communication components includes a managed network protocol (MNP) driver and a common internet file system (CIFS) recovery module.

6. The method of claim 1, wherein:
the retrieving is performed via a firmware recovery operation, the firmware recovery operation securely locating, retrieving, and restoring the firmware components stored in the remote, network-accessible storage location to a boot partition (BP) located in an associated Non-Volatile Memory express (NVMe) storage device of the information handling system.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
providing an information handling system with a distributed basic input output system (BIOS);
retrieving firmware components from a remote network accessible storage location using a lean network communication stack;
storing the retrieved firmware components within the distributed BIOS; and,
initializing the information handling system using the firmware components retrieved via the lean network communications stack.

8. The system of claim 7, wherein:
the firmware components is retrieved using a common internet file system recovery protocol.

9. The system of claim 7, wherein:
the lean network communications stack comprises a plurality of network communication components, the plurality of network communication components being just sufficient to establish and maintain a communication session with the remote network accessible storage location.

10. The system of claim 9, wherein:
the plurality of network communication components includes an optimized Telecommunications Control Protocol/Internet Protocol (TCP/IP) network protocol stack, a lean secure network protocol (SNP) driver and a lean universal network driver interface (UNDI) network device driver.

11. The system of claim 9, wherein:
the plurality of network communication components includes a managed network protocol (MNP) driver and a common internet file system (CIFS) recovery module.

12. The system of claim 7, wherein:
the retrieving is performed via a firmware recovery operation, the firmware recovery operation securely locating, retrieving, and restoring the firmware components stored in the remote, network-accessible storage location to a boot partition (BP) located in an associated Non-Volatile Memory express (NVMe) storage device of the information handling system.

13. A non-transitory, computer-readable storage medium embodying computer program code, the computer program code comprising computer executable instructions configured for:
providing an information handling system with a distributed basic input output system (BIOS);
retrieving firmware components from a remote network accessible storage location using a lean network communication stack;
storing the retrieved firmware components within the distributed BIOS; and,
initializing the information handling system using the firmware components retrieved via the lean network communications stack.

14. The non-transitory, computer-readable storage medium of claim 13, wherein:
the firmware components are retrieved using a common internet file system recovery protocol.

15. The non-transitory, computer-readable storage medium of claim 13, wherein:
the lean network communications stack comprises a plurality of network communication components, the plurality of network communication components being just sufficient to establish and maintain a communication session with the remote network accessible storage location.

16. The non-transitory, computer-readable storage medium of claim 15, wherein:
the plurality of network communication components includes an optimized Telecommunications Control Protocol/Internet Protocol (TCP/IP) network protocol stack, a lean secure network protocol (SNP) driver and a lean universal network driver interface (UNDI) network device driver.

17. The non-transitory, computer-readable storage medium of claim 15, wherein:
the plurality of network communication components includes a managed network protocol (MNP) driver and a common internet file system (CIFS) recovery module.

18. The non-transitory, computer-readable storage medium of claim 13, wherein:
the retrieving is performed via a firmware recovery operation, the firmware recovery operation securely locating, retrieving, and restoring the firmware components stored in the remote, network-accessible storage location to a boot partition (BP) located in an associated Non-Volatile Memory express (NVMe) storage device of the information handling system.

19. The non-transitory, computer-readable storage medium of claim 13, wherein:
the computer executable instructions are deployable to a client system from a server system at a remote location.

20. The non-transitory, computer-readable storage medium of claim 13, wherein:
the computer executable instructions are provided by a service provider to a user on an on-demand basis.
